(19) United States
(12) Patent Application Publication
(10) Pub. No.: US 2021/0247548 A1
(43) Pub. Date: Aug. 12, 2021

(54) Anti-Fog Lens and Surface Treatment Method Thereof

(71) Applicants: Jiann Lih Optical Co., Ltd, Tainan City (TW); MiHK OPTIX LIMITED, Kwun Tong (HK)

(72) Inventors: Chen-Chang Wang-Lee, Tainan City (TW); Tak Lung Delon Cheng, Kwun Tong (HK)

(21) Appl. No.: 17/000,429

(22) Filed: Aug. 24, 2020

(30) Foreign Application Priority Data
Feb. 6, 2020 (TW) 109103768

(51) Int. Cl. G02B 1/18; C09D 5/00; C09D 101/12

(52) U.S. Cl. CPC G02B 1/18; C09D 5/00; C25D 5/56; C09D 5/002; C09D 101/12

(57) ABSTRACT

An anti-fog lens including a lens and an anti-fog layer. The lens having a first surface and a second surface. The anti-fog layer is disposed on a side of the first surface and a side of the second surface, and includes a modified cellulose triacetate (TAC).

### FIELD OF THE DISCLOSURE

The present disclosure relates to an anti-fog lens and a surface treatment method for a lens, and more particularly to an anti-fog lens having an anti-fog layer comprising a modified cellulose triacetate (TAC), and the surface treatment method thereof.

### BACKGROUND OF THE DISCLOSURE

Generally, various types of lenses have two common problems to be solved which are lack of strength of the lenses and the fogging on the surfaces of the lenses.

Lenses are typically worn on faces, especially close to the mouth and the nose of the wearer. Therefore, the temperature of the warm moisture exhales from human body and the moisture presented in a closed space formed around the eyes (for example in the case of goggles such as swimming goggles, diving goggles or snow goggles) often being reduced to be lower than the boiling point (the condensation point) so that those moistures are condensed to form liquid water when contacting with the lenses having lower temperature. The phenomenon described above is so-called “fogging”.

On the other hand, since the material of a lens is typically selected from glass, resin and polycarbonate, in the case that the lens made of glass, the hardness of the lens is similar to that of the sands (dusts, which are mainly composed of silicon dioxide), and hence, the lens is easily being scratched.

In the existing art, it is known to immerse the lens in specific solutions (“reinforcing solutions”) to achieve anti-fog or reinforcing effect of the lens by adjusting the degree of immersion (the degree of modification). Small degree of modification is able to induce the lotus effect on the surface of the lens and reduce the surface tension of water, thereby rendering the moisture to condense and form a single layer of water film for avoiding fogging. On the other hand, larger degree of modification results the formation of a copolymer of silicon dioxide and organosilane molecules, thereby reinforce the strength of the lens.

However, it is difficult to achieve the small degree of modification and the larger degree of modification at the same time. Even if the above different degrees of modification can be achieved at the same time, it is still challenged to adjust the anti-fog effect and reinforcing effect required by the lenses for different applications.

Moreover, the reinforcing layers or electroplating layers formed by conventional immersion plating processes or evaporation deposition processes can be easily peeled off and have limited strength.

Therefore, there is a need to provide a solution to achieve both the anti-fog and reinforcing effects—even additional effects—of the lenses according to different needs for different applications. In addition, a simplified manufacturing process and improved yields are also highly desired.

### SUMMARY OF THE DISCLOSURE

In response to the above-referenced technical inadequacies, the present disclosure provides an anti-fog lens (an anti-fog spherical lens or an anti-fog aspherical lens) and a surface treatment method for the anti-fog spherical lens or the anti-fog aspherical lens.

In one aspect, the present disclosure provides an anti-fog lens comprising a lens having a first surface and a second surface, and an anti-fog layer disposed on a side of the first surface and a side of the second surface. The anti-fog layer comprises a modified triacetyl cellulose (TAC).

In certain embodiments, the anti-fog layer directly covers at least one of the first surface and the second surface.

In certain embodiments, the anti-fog lens further comprises a reinforcing layer disposed either between the first surface and the anti-fog layer on the first surface, between the second surface and the anti-fog layer on the second surface, or between the first surface and the anti-fog layer on the first surface and between the second surface and the anti-fog layer on the second surface, wherein the reinforcing layer comprises a material selected from the group consisting of polyethylene terephthalate (PET), polyethylene (PE), polyvinyl chloride (PVC), polypropylene (PP), modified polyphenylene oxide (MPPO), polysulfone, polyethersulfone (PES), polyetherimide (PEI), polyamide-imide (PAI), polyurethane (PU), polystyrene (PS), polycarbonate (PC), polymethylmethacrylate (PMMA), polylactic acid (PLA) and Acrylonitrile Butadiene Styrene (ABS).

In certain embodiments, the anti-fog lens further comprises an electroplating layer disposed either between the first surface and the anti-fog layer on the first surface, between the second surface and the anti-fog layer on the second surface, or between the first surface and the anti-fog layer on the first surface and between the second surface and the anti-fog layer on the second surface.

In certain embodiments, the anti-fog lens further comprises a reinforcing layer disposed between the anti-fog layer and the electroplating layer.

In addition to the application for spherical lenses, the present disclosure can be used for aspherical lenses. The present disclosure further provides an anti-fog lens comprising an aspherical lens having a first surface and a second surface, and an anti-fog layer disposed on a side of the first surface and a side of the second surface. The anti-fog layer comprises a modified triacetyl cellulose (TAC).

Furthermore, in one aspect, the present disclosure provides surface treatment methods for lenses. The methods include those applied on spherical lenses and on aspherical lens. The methods are described herein.

A method for a (spherical) lens comprises: a preparing step comprising providing a spherical lens having a first surface and a second surface; and an adhering step comprising adhering an anti-fog film onto the first surface and the second surface.

In certain embodiments, the adhering step is performed by scrolling the anti-fog film onto the first surface and the second surface.

In certain embodiments, the method further comprises, between the preparing step and the adhering step: a reinforcing step, comprising: immersing the spherical lens in a solution comprising silicon dioxide or an organosilane molecular copolymer.

In certain embodiments, the method further comprises, between the preparing step and the adhering step: an electroplating step, comprising electroplating the spherical lens.

In certain embodiments, the method further comprises, between the reinforcing step and the adhering step: an electroplating step, comprising electroplating the spherical lens.

In certain embodiments, the adhering step comprises holding the anti-fog film by a mechanical arm and adhering the anti-fog film onto the first surface.

In one aspect, the present disclosure provides a surface treatment method for a (aspherical) lens, comprising: a preparing step comprising providing an aspherical lens having a first surface and a second surface, and placing the aspherical lens and an anti-fog film in a mold; and an injecting step, comprising performing inject-molding using the mold to adhere the anti-fog film onto the second surface.

In certain embodiments, the method further comprises, after the injecting step: a reinforcing step comprising spray-coating a solution on the first surface, wherein the solution comprises silicon dioxide or an organosilane molecular copolymer.

In certain embodiments, the method further comprises, after the injecting step: an electroplating step comprising electroplating the first surface.

In certain embodiments, the method further comprises an adhering step comprising holding the anti-fog film by a mechanical arm and adhering the anti-fog film onto the first surface.

Therefore, the advantages of the present disclosure reside in that the reinforcement of the lens and the anti-fog effect can be both achieved by the use of the anti-fog layer and the solution or the electroplating process. It should be noticed that the adhering step for the spherical lens and that of the aspherical lens are significantly different. For example, in the case of a spherical lens, the anti-fog film can be adhered onto the spherical lens by scrolling, while in the case of an aspherical lens, since the aspherical lens includes a structure with various curvatures and without a same spherical center, the scrolling process is relatively less applicable. Therefore, the present disclosure further provides a method including a step for adhering the anti-fog film onto the aspherical lens.

In addition, the present disclosure further discloses a one-step surface treatment method comprising placing the anti-fog film in a mold and performing an inject-molding process to prepare an aspherical lens with an anti-fog layer thereon. The one-step surface treatment method can be applied on both spherical lenses and aspherical lenses.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The present disclosure will become more fully understood from the following detailed description and accompanying drawings.

FIG. 1 is a schematic view of a spherical lens according to an embodiment of the present disclosure.

FIG. 2 is a schematic view of a (spherical) anti-fog lens according to an embodiment of the present disclosure.

FIG. 3 is a schematic view of a (spherical) anti-fog lens according to another embodiment of the present disclosure.

FIG. 4 is a schematic view of a (spherical) anti-fog lens according to yet another embodiment of the present disclosure.

FIG. 5A and FIG. 5B are schematic views of (spherical) anti-fog lenses according to various embodiments of the present disclosure.

FIG. 6 is an aspherical lens according to an embodiment of the present disclosure.

FIG. 7 is a schematic view of an (aspherical) anti-fog lens according to an embodiment of the present disclosure.

FIG. 8 is a schematic view of an (aspherical) anti-fog lens according to another embodiment of the present disclosure.

FIG. 9 is a schematic view of an (aspherical) anti-fog lens according to yet another embodiment of the present disclosure.

FIG. 10 is a schematic view of an (aspherical) anti-fog lens according to yet another embodiment of the present disclosure.

FIG. 11 a schematic view of a (aspherical) anti-fog lens according to yet another embodiment of the present disclosure.

FIG. 12 to FIG. 16 are the steps of a surface treatment method corresponding to the (spherical) anti-fog lenses shown in FIG. 2 to FIG. 4, FIG. 5A and FIG. 5B respectively.

FIG. 17 to FIG. 21 are the steps of a surface treatment method corresponding to the (aspherical) anti-fog lenses shown in FIG. 7 to FIG. 11 respectively.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a”, “an”, and “the” includes plural reference, and the meaning of “in” includes “in” and “on”. Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first”, “second” or “third” can be used to describe various components, signals or the like, which are for distinguishing one component/signal from another one only, and are not intended to, nor should be construed to impose any substantive limitations on the components, signals or the like.

In addition, the directional indications (such as above, under, left, right, front, rear . . . ) in the embodiments are only used to describe the relative positions or movements, etc. of multiple components under specific circumstances (such as those shown in the drawings), and when the circumstances are changed, the directional indications may be changed accordingly.

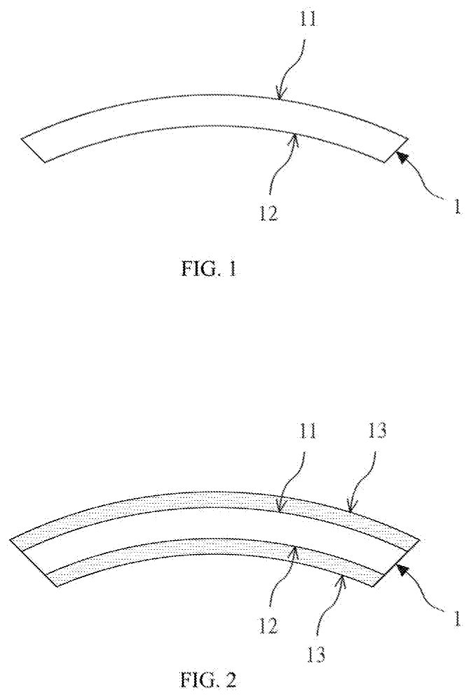

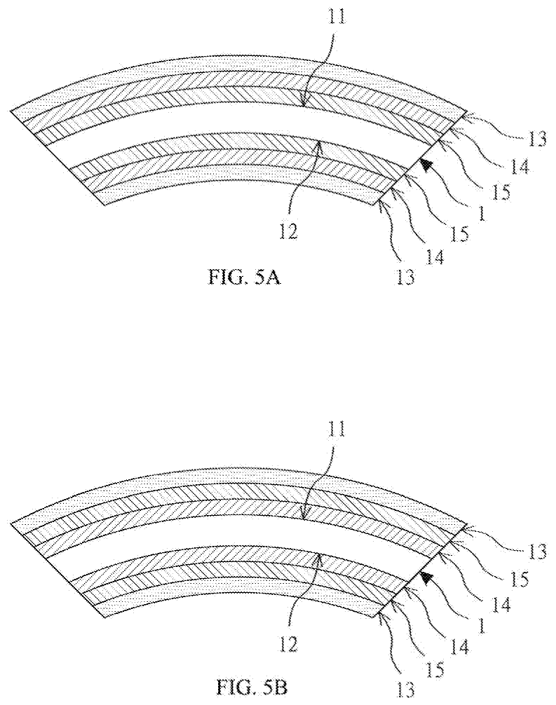

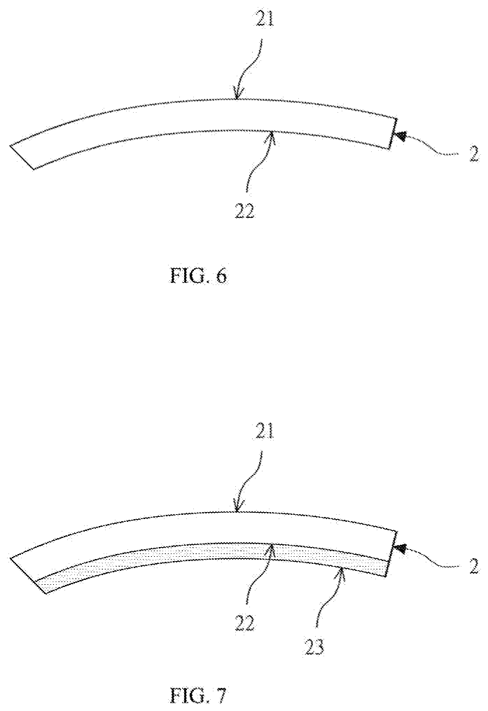

The anti-fog lenses (shown in FIG. 2 to FIG. 4, FIG. 5A and FIG. 5B) manufactured using a spherical lens 1 (as shown in FIG. 1), the anti-fog lenses (shown in FIG. 7 to FIG. 11) manufactured using an aspherical lens 2 (as shown in FIG. 6) and the surface treatment methods for spherical and aspherical anti-fog lenses are sequentially described below.

As shown in FIG. 1, a spherical lens 1 or a flat lens can be provided in advance for manufacturing an anti-fog lens. The spherical lens 1 is a lens with only one sphere center, and can be, for example, a lens with relatively high transmittance (such as a convex lens, a concave lens, a flat lens, etc.), or a mirror with relatively low, extremely low or no transmittance (such as a convex mirror, a concave mirror, a flat mirror, etc.). However, the present disclosure is not limited thereto.

As shown in FIG. 2, an anti-fog film can be held by an operator (a human) or a mechanical arm in order to be adhered onto a first surface 11 and a second surface 12 of the spherical lens 1 for forming an anti-fog layer 13, thereby providing an anti-fog lens with anti-fog effect on both surfaces thereof. In some embodiments of the present disclosure, the first surface 11 and the second surface 12 are opposite to each other. It should be noted that, the anti-fog film can have adherence itself, for example, have an adhesive included therein to directly adhere onto the first surface 11 and the second surface 12 of the spherical lens 1. In other words, the anti-fog film is a film with adherence before adhering onto the spherical lens 1.

The spherical lens 1 shown in FIG. 1 or the aspherical lens shown in FIG. 2 are made of a material selected from the group consisting of Polycarbonate (PC), Triacetate Cellulose Film (AC), NYLON, resin lens (CR-39), Polymethylmethacrylate (PMMA), Polyethylene terephthalate (PET), Polypropylene (PP) or any combination thereof.

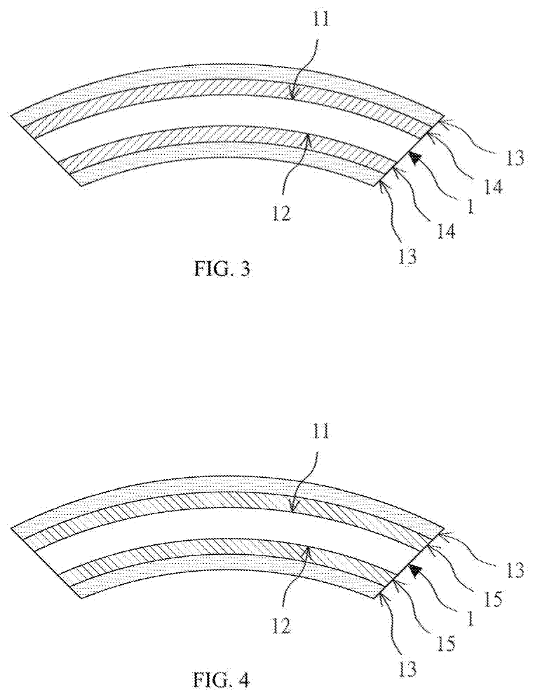

As shown in FIG. 3, before adhering the anti-fog film onto the spherical lens 1, the spherical lens 1 can be immersed in a reinforcing solution. The reinforcing solution can comprise, for example, a material selected from the group consisting of Polyethylene terephthalate (PET), Polyethylene (PE), Polyvinyl chloride (PVC), Polypropylene (PP), Modified Polyphenylene Oxide (MPPO), Polysulfone, Polyethersulfone (PES), Polyetherimide (PEI), Polyamide-imide (PAI), Polyurethane, (PU), Polystyrene (PS), Polycarbonate (PC), Polymethylmethacrylate (PMMA), Polylactic Acid (PLA) and Acrylonitrile Butadiene Styrene (ABS). However, the present disclosure is not limited thereto.

In the present embodiment, an organic or inorganic reinforcing layer 14 is formed on the surface of the spherical lens 1 by immersing the spherical lens 1 in the reinforcing solution. The thickness of the reinforcing layer 14 can be, for example, in the range of from 0.1 mm to 0.3 mm, and hence, the spherical lens 1 can have an anti-scratching property and be durable. Next, the anti-fog film is adhered onto the first surface 11 and the second surface 12 of the spherical lens 1 for forming the anti-fog layer 13. Therefore, the anti-fog lens provided by the present disclosure can have both the anti-scratching property and the anti-fog property.

It should be noticed that the step of immersing the spherical lens 1 and the step of adhering the anti-fog film are each independent and can be performed separately. Therefore, a user or a manufacturer can adjust the degrees of reinforcement and anti-fog effect according to actual needs.

As shown in FIG. 4, before adhering the anti-fog film onto the spherical lens 1, the spherical lens 1 is immersed in an electroplating solution for performing an electroplating process, thereby forming an electroplating layer 15 on the first surface 11 and the second surface 12 of the spherical lens 1.

The material of the electroplating layer 15 can be selected from nickel, copper, zinc, gold, silver or the any combination thereof. In addition, the electroplating layer 15 can be but not limited to a multi-layer electroplating coating, a water-repellent plating coating, a greaseproof coating, an anti-reflective coating, an anti-blue light coating, a mercury coating or a color mirror coating.

As shown in FIG. 5A and FIG. 5B, before adhering the anti-fog film, the reinforcing step and the electroplating step can be performed on the spherical lens 1 in advance. The difference between FIG. 5A and FIG. 5B is that in FIG. 5A, before adhering the anti-fog film, an electroplating step is performed and then a reinforcing step is performed, and in FIG. 5B, before adhering the anti-fog film, a reinforcing step is performed and then an electroplating step is performed.

Another preferred embodiment of the present disclosure is described herein. In the preferred embodiment, an anti-fog lens (shown in FIG. 7 to FIG. 11) is manufactured using an aspherical lens 2 (as shown in FIG. 6).

As shown in FIG. 6, an aspherical lens 2 is provided for manufacturing the anti-fog lens. The spherical lens 2 is a lens with multiple center of spheres, for example, a lens with relatively high transmittance (such as a convex lens, a concave lens, a flat lens, a parabolic lens, etc.), or a mirror with relatively low, extremely low or no transmittance (such as a convex mirror, a concave mirror, a flat mirror, a parabolic lens, etc.). However, the present disclosure is not limited thereto.

As shown in FIG. 7, since the structure of the aspherical lens 2 includes multiple curvatures and does not have a same center of sphere, it is difficult to adhere the anti-fog film onto the aspherical lens 2 by scrolling. Therefore, in the present embodiment, the anti-fog film is placed in a mold and an inject-molding process is performed based on the mold to adhere the anti-fog film onto the second surface 22 of the lens while the lens is formed by the inject-molding process. The second surface 22 can be the inner surface of the aspherical lens 2. Therefore, the anti-fog layer 23 can be formed on the second surface 22.

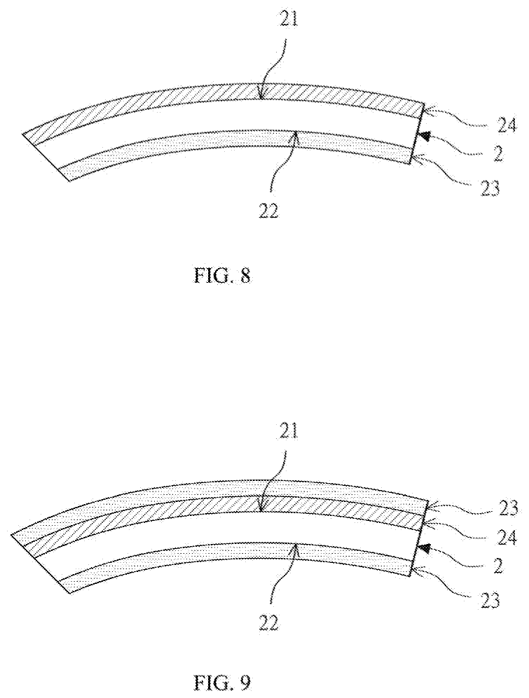

As shown in FIG. 8, a solution can be applied to the first surface 21 of the anti-fog lens which has the anti-fog film adhered to the second surface 22 thereof (as shown in FIG. 7) by spray-coating, and the solution comprises silicon dioxide or an organosilane molecular copolymer. Therefore, the first surface 21 of the anti-fog lens is reinforced, and the second surface 22 still has the anti-fog property. Therefore, the fogging problem caused by the condensation of the moisture exhaled from human body (such as sweat or steam) on the surface of the lens can be solved.

As shown in FIG. 9, in another embodiment, an anti-fog film can be further adhered on the first surface 21 and the reinforcing layer 24 of the anti-fog lens having the anti-fog film 23 adhered to the second surface 22 and the reinforcing layer 24 disposed on a side (the outer side) of the first surface 21 by holding the additional anti-fog film by a mechanical arm, i.e., an anti-fog film is further adhered to a position remote from the first surface 21 relative to the reinforcing layer 24. In other words, the reinforcing layer 24 is disposed between the first surface 21 and the additional anti-fog layer 23 adhered by the mechanical arm. Therefore, the inner side of the anti-fog lens has the anti-fog property, and the anti-fog lens itself has improved strength and wear-resistance. More importantly, the problem relating to the condensation of the moisture on the surface of the lens (the side close to the first surface 21) caused by the temperature reduction of the warm moisture exhales from human body while contacting with the lens with lower temperature when the lens are wore on the face and near the mouth and nose can be solved.

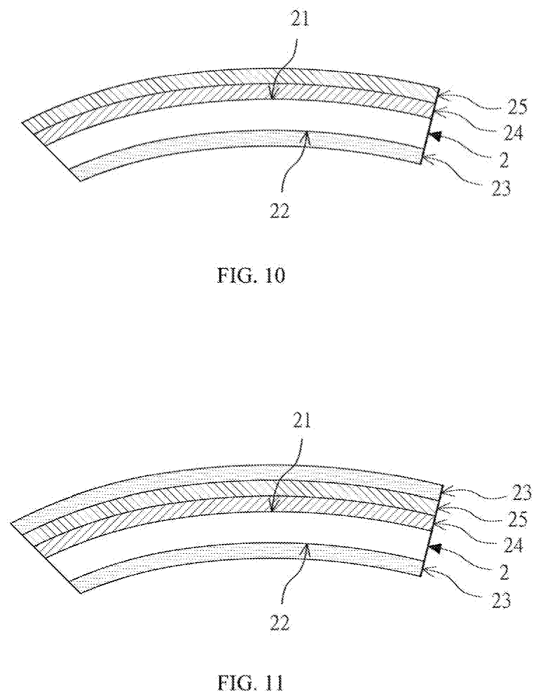

As shown in FIG. 10, in an embodiment, an electroplating process can be further performed on the anti-fog lens with the anti-fog film adhered to the second surface 22 and the reinforcing layer 24 on a side (the outer side) of the first surface 21 (as shown in FIG. 8) for forming an electroplating layer 25 on the first surface 21 and the reinforcing layer 24, i.e., the electroplating layer 25 is formed on a position remote from the first surface 21 relative to the reinforcing layer 24. In other words, the reinforcing layer 24 is disposed between the first surface 21 and the electroplating layer 25. The material of the electroplating layer 25 comprises a material selected from nickel, copper, zinc, gold, silver or any combination thereof. Based on the electroplating process, the anti-fog lens of the present embodiment can have the anti-fogging property on the inner side thereof, and the anti-fog lens itself can have improved strength and wear-resistance as well. More importantly, the materials of the electroplating layers can be selected according to the requirements of the products (such as UV-resistant, blue light-resistant, etc.).

As shown in FIG. 11, in an embodiment, an anti-fog film can be further adhered to the first surface 21 and the reinforcing layer 24 of the anti-fog lens having the anti-fog film adhered onto the second surface 22 and the reinforcing layer 24 and the electroplating layer 25 disposed on the first surface 21 (as shown in FIG. 8) by holding the additional anti-fog film by a mechanical arm, i.e., the additional anti-fog film is adhered to a position remote from the first surface 21 relative to the reinforcing layer 24. In other words, the anti-fog film is adhered to the outer side of the anti-fog lens, and the reinforcing layer 24 is disposed between the first surface 21 and the additional anti-fog layer. Therefore, the anti-fog lens of the present embodiment has the anti-fog property on both the outer side and the inner side, and the anti-fog lens of the present embodiment has the properties of improved strength and wear-resistance itself. In addition, the material of the electroplating layer 25 can be selected according to the requirements of the product (such as UV-resistant, blue light-resistant, etc.).

The surface treatment method of the anti-fog lens described above (using a spherical lens as a substrate) is described herein. The order of the steps can be adjusted based on actual needs and hence, are not limited to the description herein. The method comprises a preparing step of providing a spherical lens 1 having a first surface 11 and a second surface 21; an adhering step of adhering an anti-fog film onto the first surface 11 and the second surface 12; a reinforcing step of immersing the spherical lens 1 in a solution comprising silicon dioxide or an organosilane molecular copolymer; and an electroplating step of electroplating the spherical lens 1.

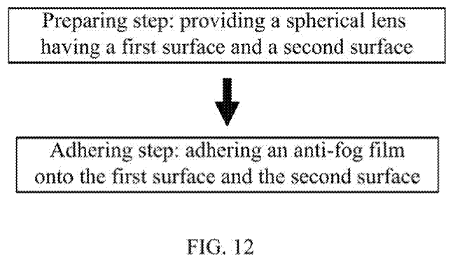

As shown in FIG. 12, the anti-fog lens shown in FIG. 2 can be manufactured by a method comprising the preparing step and the adhering step sequentially, and the adhering step can be performed by, for example, scrolling the anti-fog film onto the spherical lens 1. However, the present disclosure is not limited thereto.

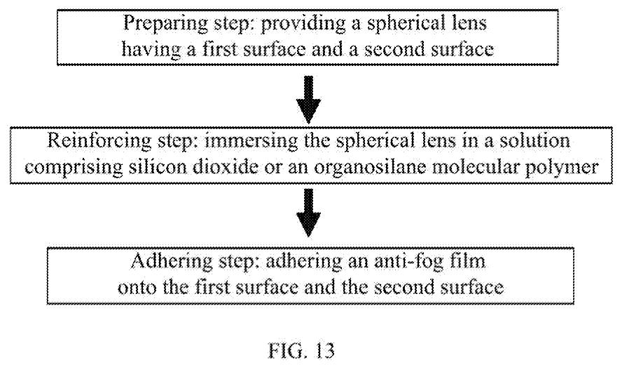

As shown in FIG. 13, the anti-fog lens shown in FIG. 3 can be manufactured by a method comprising the preparing step, the reinforcing step and the adhering step sequentially.

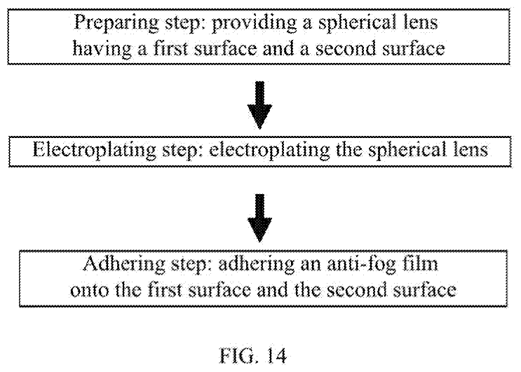

As shown in FIG. 14, the anti-fog lens shown in FIG. 4 can be manufactured by a method comprising the preparing step, the electroplating step and the adhering step sequentially.

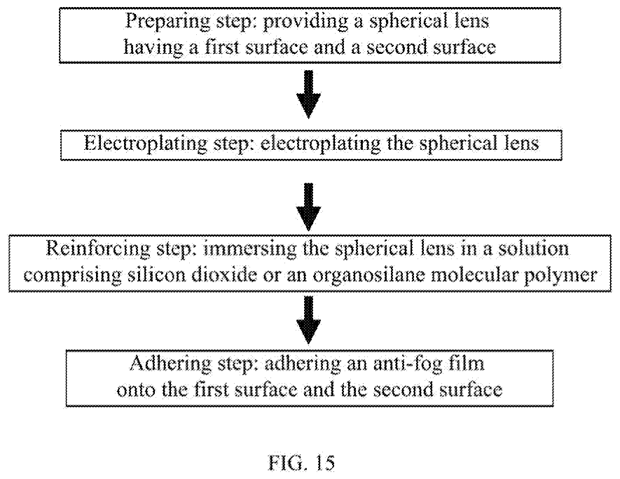

As shown in FIG. 15, the anti-fog lens shown in FIG. 5A can be manufactured by a method comprising the preparing step, the electroplating step, the reinforcing step and the adhering step sequentially.

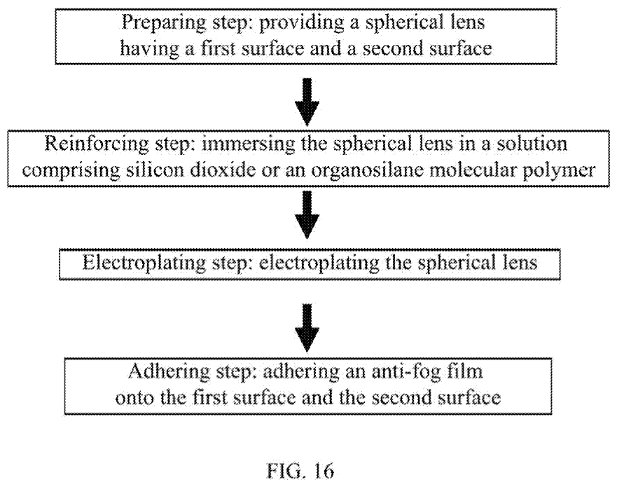

As shown in FIG. 16, the anti-fog lens shown in FIG. 5B can be manufactured by a method comprising the preparing step, the reinforcing step, the electroplating step and the adhering step sequentially.

The surface treatment method of the anti-fog lens (using an aspherical lens as a substrate) described above is described herein. The order of the steps can be adjusted based on actual needs and hence, are not limited to the description herein. The method comprises:

(1) A preparing step: providing an aspherical lens 2 having a first surface 21 and a second surface 22 and placing the aspherical lens 2 and an anti-fog film in a mold;

(2) An injecting step: performing inject-molding by the mold to adhering the anti-fog film onto the aspherical lens 2 (for example, onto the second surface 22 of the aspherical lens 2);

(3) A reinforcing step: spray-coating a solution comprising silicon dioxide and an organosilane molecular polymer onto, for example, the first surface of the aspherical lens 2 (rather than immersing the aspherical lens 2 in the solution);

(4) An electroplating step: electroplating, for example, the first surface 21 of the aspherical lens 2; and

(5) An adhering step: adhering an anti-fog film onto, for example, the first surface 21 of the aspherical lens 2.

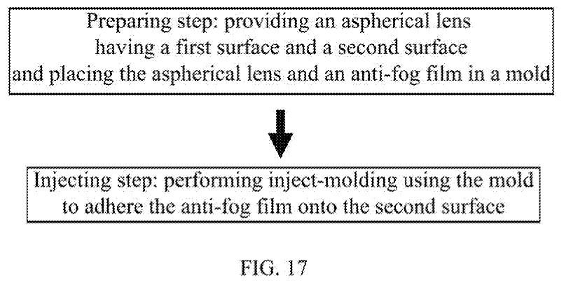

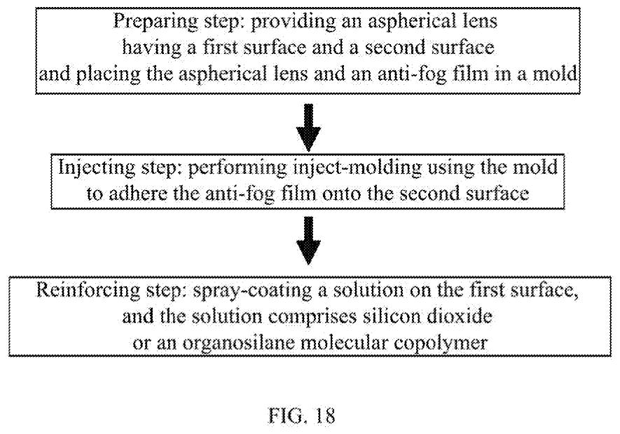

As shown in FIG. 17, the anti-fog lens shown in FIG. 7 can be manufactured by a method comprising the preparing step and the injecting step sequentially.

As shown in FIG. 18, the anti-fog lens shown in FIG. 8 can be manufactured by a method comprising the preparing step, the injecting step and the reinforcing step sequentially.

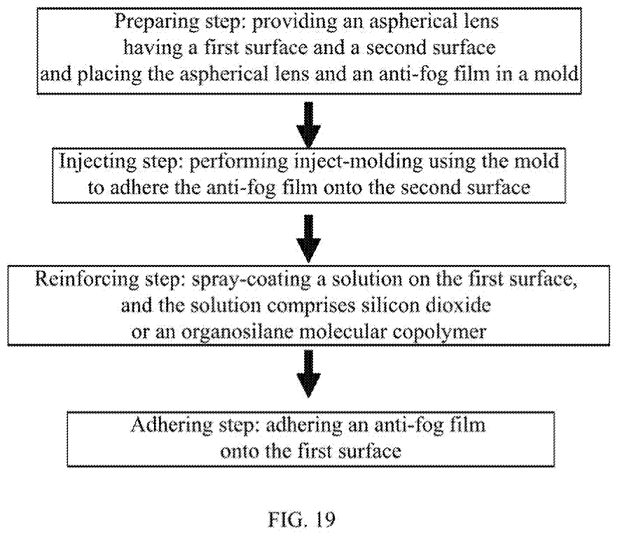

As shown in FIG. 19, the anti-fog lens shown in FIG. 9 can be manufactured by a method comprising the preparing step, the injecting step, the reinforcing step and the adhering step sequentially.

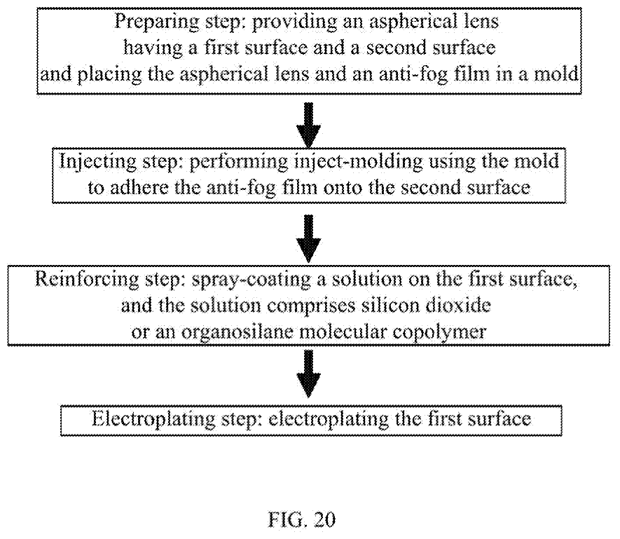

As shown in FIG. 20, the anti-fog lens shown in FIG. 10 can be manufactured by a method comprising the preparing step, the injecting step, the reinforcing step and the electroplating step sequentially.

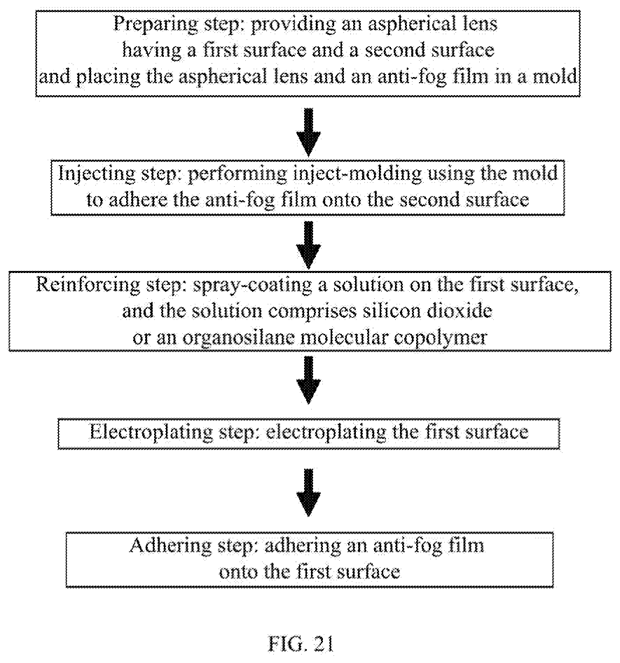

As shown in FIG. 21, the anti-fog lens shown in FIG. 11 can be manufactured by a method comprising the preparing step, the injecting step, the reinforcing step, the electroplating step and the adhering step sequentially. It should be noted that as the adhering step is the final step, a side of the first surface of the anti-fog lens (the outer side of the anti-fog lens) has the anti-fog property as well.

In sum, the surface treatment methods for spherical and aspherical lenses can be used to manufactured various type of anti-fog lenses. Therefore, the anti-fog property of the lens can be adjusted, or both the anti-fog property and the reinforcing property can be achieved at the same time. In addition, the degrees of anti-fogging and reinforcement can be adjusted based on actual needs. It should be mentioned that the process of manufacturing the aspherical anti-fog lens in a single step (using the inject-molding process) can be applied to the spherical lens as well, and such process can reduce the number of step in the manufacturing process and improve the yield of the manufacturing process.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. An anti-fog lens, comprising:
a lens having a first surface and a second surface; and
an anti-fog layer disposed on a side of the first surface and a side of the second surface, the anti-fog layer comprising a modified triacetyl cellulose (TAC).

2. The anti-fog lens according to claim 1, wherein the anti-fog layer directly covers at least one of the first surface and the second surface.

3. The anti-fog lens according to claim 1, further comprising a reinforcing layer disposed either between the first surface and the anti-fog layer on the first surface, between the second surface and the anti-fog layer on the second surface, or between the first surface and the anti-fog layer on the first surface and between the second surface and the anti-fog layer on the second surface, wherein the reinforcing layer comprises a material selected from the group consisting of polyethylene terephthalate (PET), polyethylene (PE), polyvinyl chloride (PVC), polypropylene (PP), modified polyphenylene oxide (MPPO), polysulfone, polyethersulfone (PES), polyetherimide (PEI), polyamide-imide (PAI), polyurethane (PU), polystyrene (PS), polycarbonate (PC), polymethylmethacrylate (PMMA), polylactic acid (PLA) and Acrylonitrile Butadiene Styrene (ABS).

4. The anti-fog lens according to claim 1, further comprising an electroplating layer disposed either between the first surface and the anti-fog layer on the first surface, between the second surface and the anti-fog layer on the second surface, or between the first surface and the anti-fog layer on the first surface and between the second surface and the anti-fog layer on the second surface.

5. The anti-fog lens according to claim 4, further comprising a reinforcing layer disposed between the anti-fog layer and the electroplating layer.

6. A surface treatment method for a lens, comprising:
a preparing step comprising providing a spherical lens having a first surface and a second surface; and
an adhering step comprising adhering an anti-fog film onto the first surface and the second surface.

7. The method according to claim 6, wherein the adhering step is performed by scrolling the anti-fog film onto the first surface and the second surface.

8. The method according to claim 6, further comprising, between the preparing step and the adhering step:
a reinforcing step, comprising: immersing the spherical lens in a solution comprising silicon dioxide or an organosilane molecular copolymer.

9. The method according to claim 6, further comprising, between the preparing step and the adhering step:
an electroplating step, comprising electroplating the spherical lens.

10. The method according to claim 8, further comprising, between the reinforcing step and the adhering step:
an electroplating step, comprising electroplating the spherical lens.

11. A surface treatment method for a lens, comprising:
a preparing step, comprising providing an aspherical lens having a first surface and a second surface, and placing the aspherical lens and an anti-fog film in a mold; and
an injecting step, comprising performing inject-molding using the mold to adhere the anti-fog film onto the second surface.

12. The method according to claim 11, further comprising, after the injecting step:
a reinforcing step, comprising spray-coating a solution on the first surface, wherein the solution comprises silicon dioxide or an organosilane molecular copolymer.

13. The method according to claim 11, further comprising, after the injecting step:
an electroplating step comprising electroplating the first surface.

14. The method according to claim 11, further comprising an adhering step comprising holding the anti-fog film by a mechanical arm and adhering the anti-fog film onto the first surface.

15. The method according to claim 12, further comprising an adhering step comprising holding the anti-fog film by a mechanical arm and adhering the anti-fog film onto the first surface.

16. The method according to claim 13, further comprising an adhering step comprising holding the anti-fog film by a mechanical arm and adhering the anti-fog film onto the first surface.
